(19) United States
(12) Patent Application Publication
(10) Pub. No.: US 2026/0082393 A1
(43) Pub. Date: Mar. 19, 2026

(54) RADIO LINK CONTROL (RLC) STATUS REPORTING

(71) Applicant: QUALCOMM Incorporated, San Diego, CA (US)

(72) Inventors: Sherif ELAZZOUNI, San Diego, CA (US); Sitaramanjaneyulu KANAMARLAPUDI, San Diego, CA (US); Gavin Bernard HORN, La Jolla, CA (US); Ozcan OZTURK, San Diego, CA (US)

(21) Appl. No.: 18/889,170

(22) Filed: Sep. 18, 2024

(51) Int. Cl. H04W 72/231; H04W 72/542

(52) U.S. Cl. CPC H04W 72/231; H04W 72/542

(57) ABSTRACT

A method of wireless communication by a user equipment (UE) includes receiving a configuration for a format type of a radio link control (RLC) status report. The method also includes determining a size of an uplink grant, and determining a portion of the uplink grant allocated for the RLC status report based on the size of the uplink grant and the configuration for the format type. The method further includes building the RLC status report based on the configuration for the format type and the portion of the uplink grant allocated for the status report. The method still further includes transmitting the RLC status report.

### FIELD OF THE DISCLOSURE

The present disclosure relates generally to wireless communications, and more specifically to radio link control (RLC) status reporting.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a fifth generation (5G) Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method of wireless communication by a user equipment (UE) includes receiving a configuration for a format type of a radio link control (RLC) status report. The method still further includes determining a size of an uplink grant. The method also includes determining a portion of the uplink grant allocated for the RLC status report based on the size of the uplink grant and the configuration for the format type. The method further includes building the RLC status report based on the configuration for the format type and the portion of the uplink grant allocated for the status report. The method still further includes transmitting the RLC status report.

In other aspects of the present disclosure, a method of wireless communication by a network device includes transmitting a code point indicating a format type of a radio link control (RLC) status report. The method also includes receiving the RLC status report in the format type.

Other aspects of the present disclosure are directed to an apparatus. The apparatus has a one or more memories and one or more processors coupled to the one or more memories. The processor(s) is configured to receive a configuration for a format type of a radio link control (RLC) status report. The processor(s) is also configured to determine a size of an uplink grant. The processor(s) is further configured to determine a portion of the uplink grant allocated for the RLC status report based on the size of the uplink grant and the configuration for the format type. The processor(s) is also configured to build the RLC status report based on the configuration for the format type and the portion of the uplink grant allocated for the status report. The processor(s) is configured to transmit the RLC status report.

Other aspects of the present disclosure are directed to an apparatus. The apparatus has a one or more memories and one or more processors coupled to the one or more memories. The processor(s) is configured to transmit a code point indicating a format type of a radio link control (RLC) status report. The processor(s) is also configured to receive the RLC status report in the format type.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a call flow diagram illustrating radio link control (RLC) status reporting, in accordance with various aspects of the present disclosure.

FIG. 5 is a diagram illustrating an RLC status report, in accordance with various aspects of the present disclosure.

FIG. 6 is a diagram illustrating a compressed status report, in accordance with various aspects of the present disclosure.

FIG. 7 is a diagram illustrating a receive window, in accordance with various aspects of the present disclosure.

FIG. 8 is a block diagram illustrating status report sizing based on an available grant, in accordance with various aspects of the present disclosure.

FIG. 9 is a block diagram illustrating status report sizing based on an available grant and uplink data, in accordance with various aspects of the present disclosure.

FIG. 10 is a diagram illustrating status report configuration, in accordance with various aspects of the present disclosure.

FIG. 11 is a flow diagram illustrating an example process performed, for example, by a user equipment (UE), in accordance with various aspects of the present disclosure.

FIG. 12 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with fifth generation (5G) and later wireless technologies, aspects of the present disclosure can be applied in other generation-based communications systems, such as and including 3G and/or 4G technologies.

Wireless communication protocol stacks include multiple layers. The radio link control (RLC) layer resides above the media access control (MAC) layer in long term evolution (LTE), 5G, sixth generation (6G), and later air interfaces. RLC status reporting is part of RLC acknowledge mode (AM) operation. Status reporting acknowledges or negatively acknowledges each RLC transmission depending on whether or not the transmission was successfully received. RLC transmissions may be referred to as protocol data units (PDUs) or service data units (SDUs).

When operating at a high downlink rate, status reports may be delayed until an appropriate uplink (UL) grant arrives. As a result, the UE has to maintain a large data buffer (e.g., uplink data buffer), for example, for reordering data, and memory may become overloaded. Moreover, uplink throughput may drop due to prioritization of RLC status protocol data units (PDUs). For instance, uplink transmissions may suffer head-of-line (HOL) blocking.

According to aspects of the present disclosure, an artificial intelligence native solution includes an artificial intelligence/machine learning (AI/ML) model, which may more generally be referred to as a learning model, determines which status report format to transmit. The AI/ML model. The AI/ML model (e.g., learning model) exhibits new behavior, which may also include configuring a performance target and/or a range. For example, the AI/ML model may configure a full status report without any optimizations or may configure the UE with the ability to perform optimizations. The range configuration may include a set of acceptable behaviors, for example, a performance target or key performance indicator (KPI) that should be achieved, regardless of which optimization is selected. In some implementations, the UE decides how to obtain a solution to achieve the target KPI by selecting an appropriate optimization. UE reporting may help build the model, for example, by logging information that informs the network of what mechanism the UE is using and how well or poorly the optimization is performing. The UE may report AI/ML behavior to the network.

Aspects of the present disclosure introduce AI/ML native behavior that enables a UE to use an AI/ML model to build a status PDU that accounts for grant size, a predicted balancing of the grant between status reporting and uplink data transmission, a likelihood of retransmission without a status report, and/or a relative importance of obtaining a missing RLC PDU. Initially, the UE observes the available grant and/or predicts grants in the near future. Next, the UE determines a portion of the grant to use for building a status report. The UE balances the status report portion with the portion of the grant needed for uplink data traffic and MAC control elements (CEs).

The UE may then observe the status of the RLC receive window and predict unreceived RLC PDUs that are not likely to be immediately received (e.g., via hybrid automatic repeat request (HARQ)/RLC retransmission) or reported via a lost status PDU. The UE also predicts the relative importance of receiving those lost PDUs immediately, which effectively prioritizes latency sensitive traffic. Finally, after the UE determines all the information to be included in the status report, the UE may further determine the encoding of the status report to reduce or minimize the overhead.

Particular aspects of the subject matter described in this disclosure can be implemented to realize one or more of the following potential advantages. In some examples, the described techniques, such as improving RLC status reporting, may increase throughput and reduce latency.

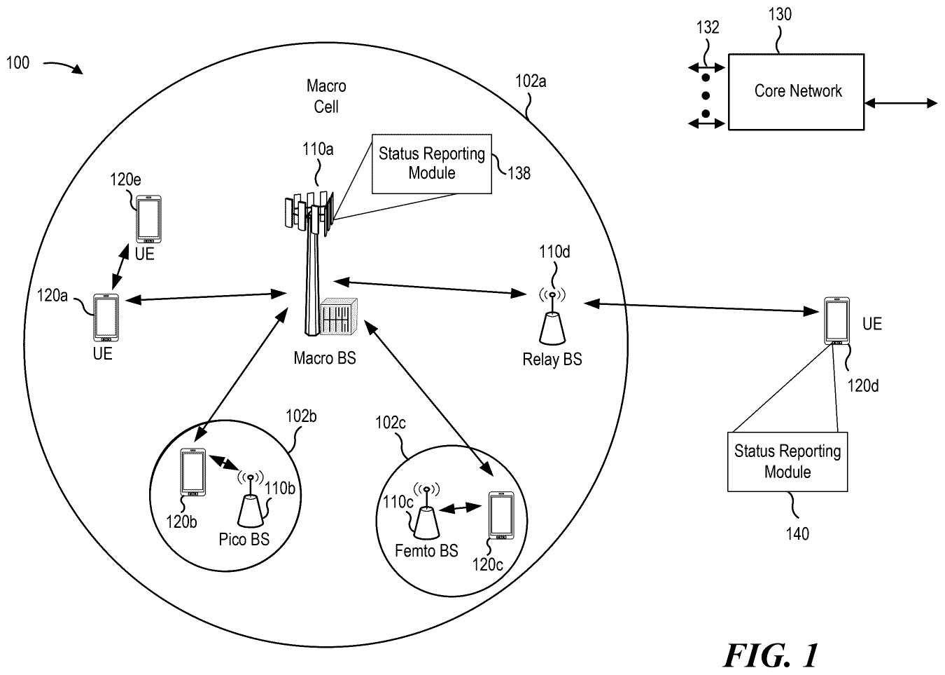

FIG. 1 is a diagram illustrating a wireless network 100 in which aspects of the present disclosure may be practiced. The wireless network 100 may be a 5G or new radio (NR) network or some other wireless network, such as an LTE network. The wireless network 100 may include a number of base stations (BSs) 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a status reporting module 140. For brevity, only one UE 120d is shown as including the status reporting module 140. The status reporting module 140 may receive a configuration for a format type of a radio link control (RLC) status report. The status reporting module 140 may determine a size of an uplink grant. The status reporting module 140 may also determine a portion of the uplink grant allocated for the RLC status report based on the size of the uplink grant and the configuration for the format type. The status reporting module 140 may build the RLC status report based on the configuration for the format type and the portion of the uplink grant allocated for the RLC status report. The status reporting module 140 may transmit the RLC status report.

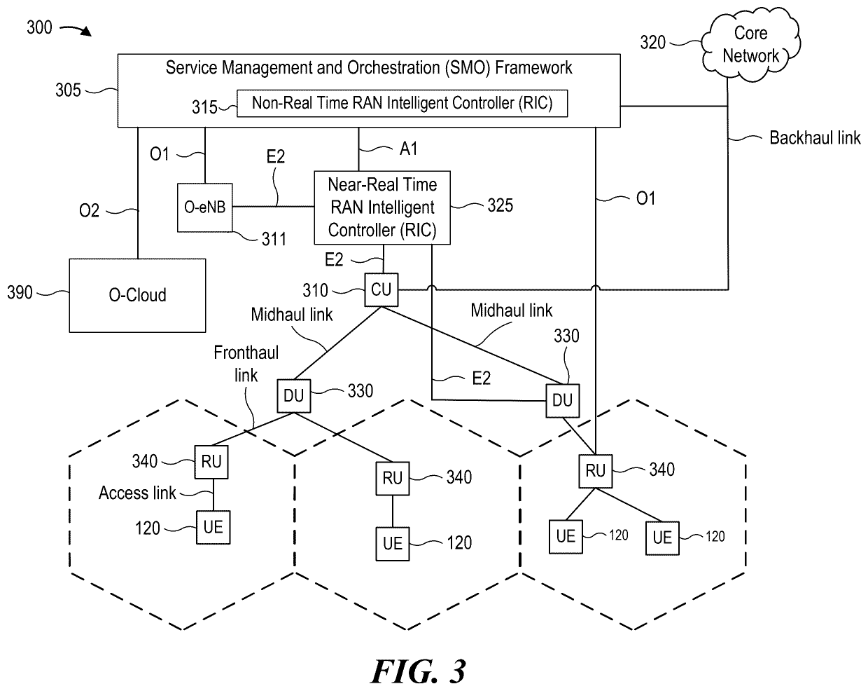

The core network 130 or the base stations 110 or any other network device (e.g., as seen in FIG. 3) may include a status reporting module 138. For brevity, only one base station 110a is shown as including the status reporting module 138. The status reporting module 138 may transmit a code point indicating a format type of a radio link control (RLC) status report. The status reporting module 138 may receive the RLC status report in the format type.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

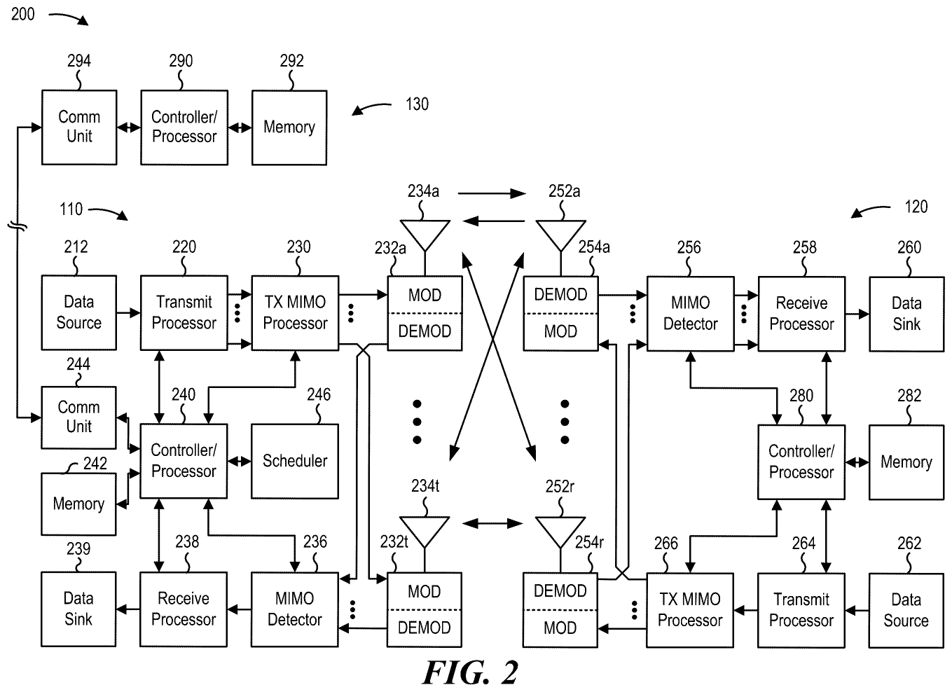

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

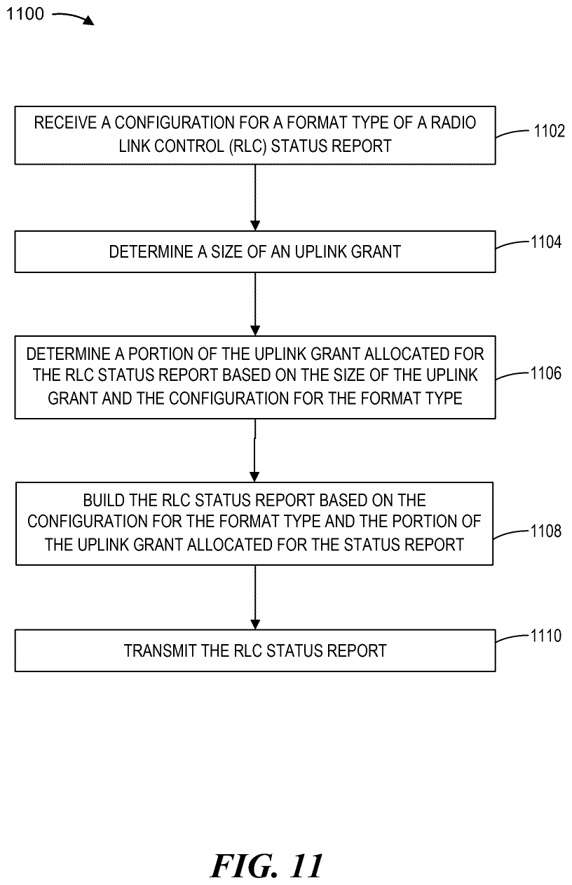

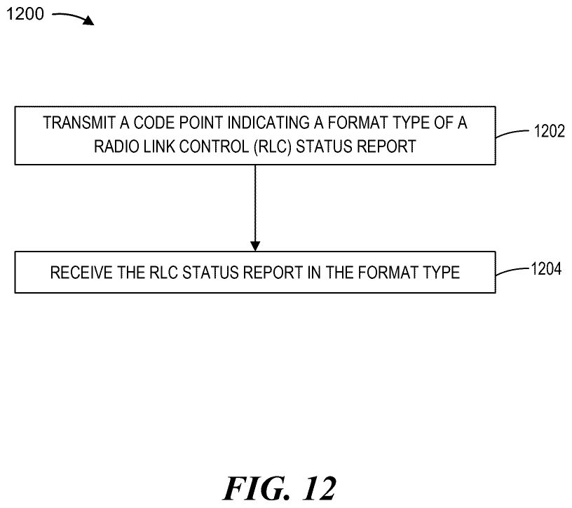

The controller/processor 240 of the base station 110, the controller/processor 280 of the UE 120, and/or any other component(s) of FIG. 2 may perform one or more techniques associated with status reporting, as described in more detail elsewhere. For example, the controller/processor 240 of the base station 110, the controller/processor 280 of the UE 120, and/or any other component(s) of FIG. 2 may perform or direct operations of, for example, the processes of FIGS. 11 and 12 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for determining, means for building, means for transmitting, means for predicting, means for storing, and means for reporting. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (cMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

Wireless communication protocol stacks include multiple layers. The radio link control (RLC) layer resides above the media access control (MAC) layer in LTE, 5G, 6G, and later air interfaces. RLC status reporting is part of RLC acknowledge mode (AM) operation. Status reporting acknowledges or negatively acknowledges each RLC transmission depending on whether or not the transmission was successfully received. RLC transmissions may be referred to as protocol data units (PDUs) or service data units (SDUs).

When operating at a high downlink rate, status reports may be delayed until an appropriate uplink (UL) grant arrives. As a result, the UE has to maintain a large receive buffer, for example, for reordering data, and memory may become overloaded. Moreover, uplink throughput may drop due to prioritization of RLC status protocol data units (PDUs). For instance, uplink transmissions may suffer head-of-line (HOL) blocking.

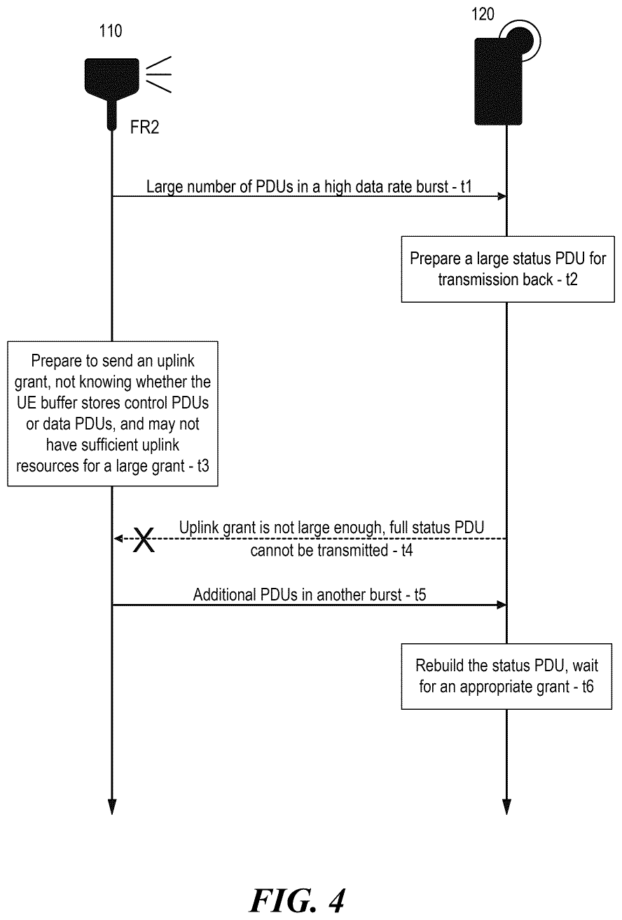

FIG. 4 is a call flow diagram illustrating status reporting, in accordance with various aspects of the present disclosure. In the example of FIG. 4, a base station 110 communicates with a UE 120. At time t1, the base station 110 (e.g., gNB) transmits a large number of PDUs in a high data rate burst to the UE 120. At time t2, the UE 120 prepares a large status PDU (also referred to as a status report) for transmission back to the base station 110. At time 3, the base station 110 prepares to send an uplink grant for the UE 120. However, because the base station 110 does not know whether the UE data buffer stores control PDUs or data PDUs, the base station 110 does not have sufficient uplink resources for a large grant. Because the uplink grant is not large enough, the UE 120 cannot transmit the full status PDU at time t4.

At time t5, the base station 110 transmits additional PDUs to the UE 120 in another data burst. At time t6, the UE rebuilds the status PDU, including the unsent information from the status PDU prepared at time t2 and also the status information for the newly transmitted PDUs at time t5. The rebuilt status PDU may be large, causing memory issues at the UE.

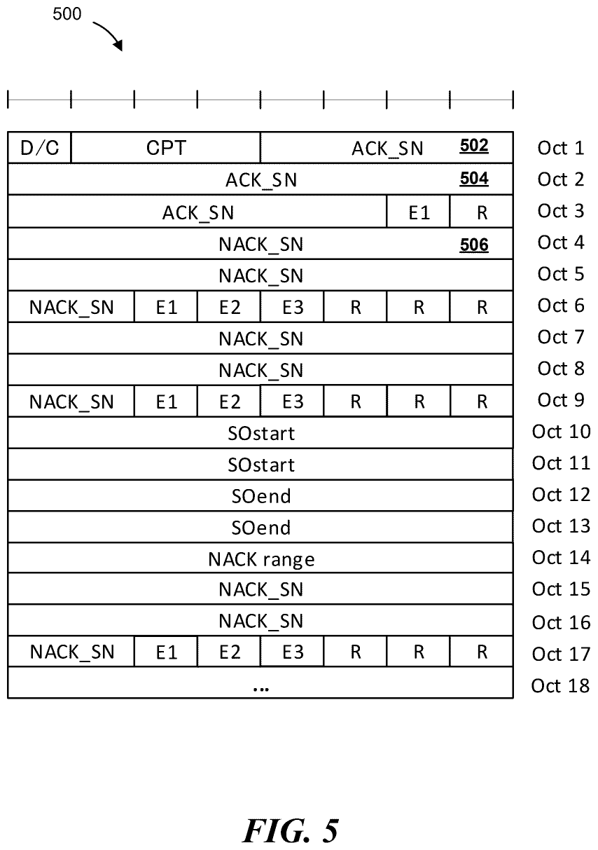

FIG. 5 is a diagram illustrating a radio link control (RLC) status report 500, in accordance with various aspects of the present disclosure. As seen in FIG. 5, the status report 500 (also referred to as a status PDU or a status message) includes a first acknowledgement for a first sequence number (ACK_SN) 502, a second acknowledgement for a second sequence number 504, and a negative acknowledgment for a third sequence number (NACK_SN) 506.

Different formats of a status PDU are available. A full status PDU, such as the full status PDU 500 illustrated in FIG. 5, is built according to 3GPP standards section 38.322. As described with respect to FIG. 4, the UE waits for a grant that is large enough for a size of the full status PDU before transmitting the full status PDU.

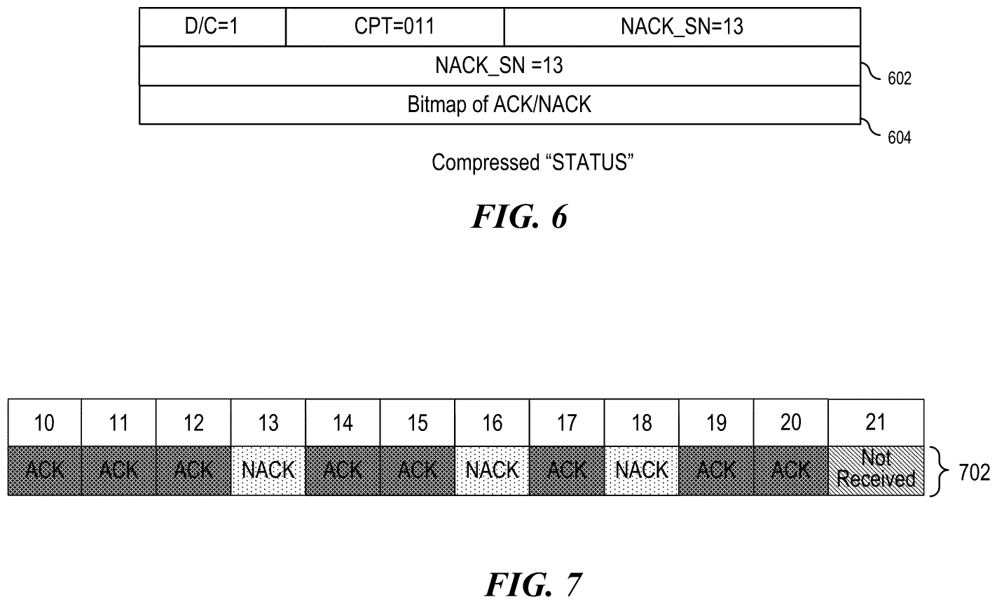

With an encoded status PDU, the UE may encode the status PDU by including a first missing sequence number (SN) and a bitmap of all received or missing PDUs. The bitmap may include a 1 or 0 for each bit to indicate whether a PDU has been successfully received. For example, a value of 1 may indicate the PDU was successfully received and a value of 0 may indicate the PDU was not successfully received, or vice versa. FIG. 6 is a diagram illustrating a compressed status report, in accordance with various aspects of the present disclosure. FIG. 7 is a diagram illustrating a receive window, in accordance with various aspects of the present disclosure. In the examples of FIGS. 6 and 7, a NACK 602 is indicated for the PDU with sequence number 13, which is the first missing sequence number in a receive window 702. A bitmap 604 indicates the reception status of the next sequence numbers in the receive window 702. In the examples of FIGS. 6 and 7, the PDU sequence numbers 16 and 18 are not successfully received, and are thus indicated as NACK in the bitmap 604. PDUs with sequence numbers 14, 15, 17, 19, and 20 are indicated as successfully received in the bitmap 604. The receive window 702 does not include sequence number 21, which is shown as ‘not received’ in FIG. 7, because the corresponding PDU has not yet been received.

A limited window status PDU is a status PDU having a size depending on a quantity of negative acknowledgment (NACK) PDUs received in the receive window. In some aspects, the UE may be interested in only communicating ACK/NACL status for part of the receive window, for example, based on the grant size. In an extreme case, the UE may only communicate Rx_Next, which is a first unreceived PDU (sequence number 13 in the example of FIG. 7). With the limited window status PDU, the UE may only communicate ACK/NACK status for part of the window, for example, if the grants are too small or if other parts of the window have not changed since transmitting the last status report (e.g., a differential status PDU). Thus, the UE may report for the whole window, the UE may report to the first loss, for example, SN=13, or the UE may report for a new part of the window, for example, after SN=17.

According to aspects of the present disclosure, an AI native solution includes an artificial intelligence/machine learning (AI/ML) model or a learning model that determines which status report format to transmit. The AI/ML model may also be more generally referred to as a learning model. The AI/ML model (e.g., learning model) exhibits new behavior, which may include configuring a performance target and/or a range at the UE. For example, the AI/ML model may configure a full status report without any optimizations or may configure the UE with the ability to perform optimizations. The range configuration may include a set of acceptable behaviors, for example, a performance target or key performance indicator (KPI) that should be achieved, regardless of which optimization is selected. In some implementations, the UE decides how to obtain a solution to achieve the target KPI by selecting an appropriate optimization. UE reporting may help build the AI/ML model, for example, by logging information that informs the network of what mechanism the UE is using and how well or poorly the optimization is performing. The UE may report AI/ML behavior to the network.

According to aspects of the present disclosure, the behavior of 6G and later status reporting in the RLC layer is specified. Currently, in an RLC acknowledge mode (AM), when a status report is triggered, the UE builds the status report as specified in the 3GPP standards (e.g., see FIG. 5). The UE then waits for an appropriate grant to transmit the status PDU. If a small grant arrives, the UE sends the portion from the status PDU that fits within the grant, but keeps rebuilding the status PDU at every grant until the status PDU is successfully transmitted.

Aspects of the present disclosure introduce AI/ML native behavior that enables a UE to use an AI/ML model to build a status PDU that accounts for grant size, a predicted balancing of the grant between status reporting and uplink data transmission, a likelihood of retransmission without a status report, and/or a relative importance of obtaining a missing RLC PDU. Initially, the UE observes the available grant and/or predicts grants in the near future. Next, the UE determines a portion of the grant to use for building a status report. The UE balances the status report portion with the portion of the grant needed for uplink data traffic and media access control-control elements (MAC-CEs).

The UE may then observe the status of the RLC receive window and predict unreceived RLC PDUs that are not likely to be immediately received (e.g., via hybrid automatic repeat request (HARQ)/RLC retransmission) or reported via a lost status PDU. The UE also predicts the relative importance of receiving those lost PDUs immediately, which effectively prioritizes latency sensitive traffic. Finally, after the UE determines all the information to be included in the status report, the UE may further determine the encoding of the status report to reduce or minimize overhead.

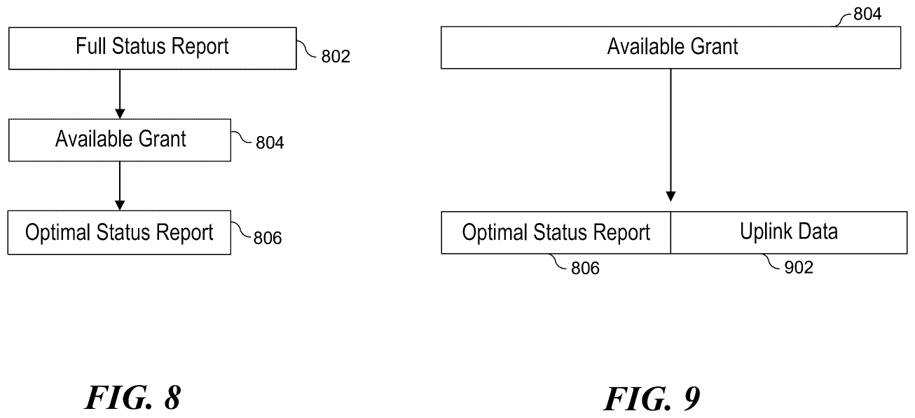

FIG. 8 is a block diagram illustrating status report sizing based on an available grant, in accordance with various aspects of the present disclosure. Currently, status report building does not account for the available size of the grant, such as when the grant may not accommodate a size of a full status report. Current status report building also does not determine which portion of the grant to use when balancing between downlink latency/reliability and uplink latency/reliability. In the example of FIG. 8, a full status report 802 does not fit within an available grant 804. The available grant 804 refers to resources granted for an uplink transmission. Thus, in accordance with aspects of the present disclosure, the UE builds an optimal status report 806 that fits within the available grant 804. In the example of FIG. 8, the optimal status report 806 includes the most important part of the receive window that needs to be reported according to the size of the available grant 804. That is, the UE may decide how to build the status report in terms of the most important part of the receive window that needs to be reported according to the size of the available grant 804.

FIG. 9 is a block diagram illustrating status report sizing based on an available grant and uplink data, in accordance with various aspects of the present disclosure. In the example of FIG. 9, the UE divides the available grant 804 between uplink data 902 and the optimal status report 806. The UE may decide how to divide the available grant 804 between uplink data 902 and the optimal status report 806 based on the available grant 804.

New behavior and model development will now be described in more detail. According to aspects of the present disclosure, the transmitter and receiver understand the status format through codepoints. For example, a full status report may correspond to codepoint (CPT)=000, which may indicate a legacy status report.

A partial status report may correspond to CPT=111. For example, at the UE, an AI/ML model may predict sequence numbers that the base station (e.g., gNB) would not retransmit immediately or predict higher priority PDUs. Such sequence numbers would be included in the partial report.

A differential status report may correspond to CPT=001. A differential status report is a status report for a new part of the receive window only, including sequence numbers that were not reported before and/or have changed status since the last report. This differential status report may include the fields SN_start and SN_end to indicate that the UE is reporting the ACK or NACK of PDUs between those bounds.

A window start status report may correspond to CPT=010. The window start status report includes only RX_next (e.g., the first unreceived PDU). This report format is appropriate for low latency traffic where the transmit and receive windows should be synchronized.

A compressed status report may correspond to CPT=100. The compressed status report is in accordance with a compression scheme known to the transmitter and receiver.

Data collection for AI/ML model development is now discussed. Potential information elements (IEs) to collect information to support the AI or machine learning (ML) model may include labels such as meta data, timestamps, etc. A goal of data collection is to improve the AI/ML model. An AI/ML model that observes RLC/HARQ parameters or events may evaluate a portion of a received grant or expected grants to be received that can be used to build a status report. The AI/ML model may also evaluate a portion of a receive window that needs to be indicated in the status report, such as described above with respect to codepoints. The AI/ML model may also evaluate an optimal status report format and a portion of the receive window to be reported. The AI/ML model may also evaluate predictions of the PDUs to be negatively acknowledged (NACKed) or reNACKed to the base station for fast retransmission.

Priority of PDUs in terms of indicating a NACK and/or obtaining a fast retransmission may also be evaluated. It is noted that although PDUs are referred to throughout this description, service data units (SDUs) are also contemplated.

Data to be collected may include logs of RLC status reports and a receive window state. For example, the log of status reports and the receive window state may indicate full or partial reporting. Portions of grant sizes received for status reporting may also be collected. Similarly, statistics on retransmission delay after status reporting, and overall latency and HARQ/RLC reliability may be collected. Based on the collected information, a map may be generated. For example, if a grant of size X is received, then a report of format Y may be selected. Alternatively, if X many NACKs are present, then a format Z report may be selected. In some aspects, the UE transmits the collected data to a network device, such as an AI/ML server.

Further aspects of the present disclosure pertain to model accuracy KPI maintenance. For example, KPIs related to performance of status reporting may be collected and occasionally reported to the network and/or a machine learning (ML) server.

In some implementations, the UE maintains one or more KPIs. For example, a KPI for excessive latency may be monitored. That is, statistics of RLC PDU latency or reliability per PDU set, quality of service (QoS) flow, or any packet categorization may be monitored. Latency below a latency threshold may be indicative of the UE under-reporting status reports. Thus, the UE may elect to implement an optimization with an AI/ML model. A KPI of the AI/ML model may also be considered. In this case, it may be determined how much (or whether) excessive status reporting is performed. This information can be inferred by duplicated PDUs received at the RLC or packet data convergence protocol (PDCP) layer. If an amount of status reporting is above a reporting threshold, the KPI may not be satisfied.

In other implementations, the network maintains KPIs. For example, the network may observe based on UE status reporting that the reporting is excessive, under-reported, or over-reported. Accordingly, the network may inform the UE of a KPI violation. In response, the UE may disable the AI/ML model and stop making optimizations. That is, the UE may fall back to legacy behavior.

Capability reporting will now be described. As discussed above, potential IEs may be collected to support the AI/ML model. For example, the UE may report a capability to support particular status reporting formats. Such formats may include full status reporting, AI optimized partial status reporting, segmented status reporting, partial status reporting, differential status reporting, and compressed status reporting. The UE may further report a model score based on KPIs, such as performance KPIs, UE maintained KPIs, and/or network maintained KPIs.

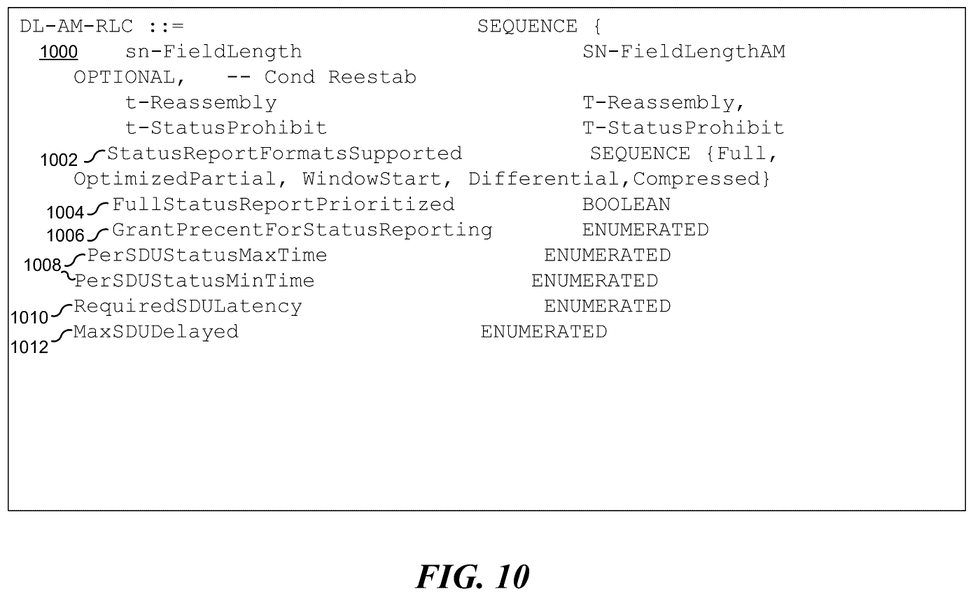

According to aspects of the present disclosure, the network may provide a range configuration and a KPI configuration for status reporting performance. FIG. 10 is a diagram illustrating status report configuration, in accordance with various aspects of the present disclosure. As seen in FIG. 10, a downlink acknowledge mode radio link control (DL-AM-RLC) information element (IE) 1000 may include a status report format supported field 1002, which indicates the status formats the UE should use based on the categories/codepoints previously described. The DL-AM-RLC IE 1000 may also include a full status report prioritized field 1004. If the full status report prioritized field 1004 is set to TRUE, the UE should report the full status when the grant is large enough. The UE may only use other formats if the grant is not large enough.

The DL-AM-RLC IE 1000 may also include a grant percentage for a status reporting field 1006. This status reporting field 1006 is a KPI for the UE on how much of the grant may be used for status reporting. For example, if the status reporting field 1006 is set to five percent, then at most five percent of all received grants can be used for status reporting. The UE may need to optimize partial status reporting accordingly.

The DL-AM-RLC IE 1000 may include per SDU status maximum time and per SDU status minimum time fields 1008. These per SDU status maximum and minimum time fields 1008 provide an upper bound on time the UE can spend between two status reports for the same SDU that is not received, and a minimum time (e.g., a prohibit timer) the UE can spend between two status reports for the same SDU that is not received.

The DL-AM-RLC IE 1000 may also include a required SDU latency field 1010 and a maximum SDU delayed field 1012. The required SDU latency field 1010 indicates a required latency for all SDUs, for example, the average latency of all SDUs. The value may be a lower bound. The maximum SDU delayed field 1012 indicates a percentage of SDUs allowed to be delayed beyond the configured bound. For example, ten percent of SDUs may be allowed to cross the bound.

KPI satisfaction and fallback will now be discussed. In these aspects of the present disclosure, the UE can be configured with a fallback behavior in case a KPI cannot be maintained (e.g., UE cannot maintain a required latency bound for a percent of SDUs that is configured as a KPI). In some aspects, the UE may be specified to fall back to legacy non-AI/ML behavior of always transmitting a full status report. For example, the UE may be specified to disable the AI/ML behavior for an RLC entity. In other aspects, the UE may be specified to send a KPI violation report to the base station or an AI/ML server.

As indicated above, FIGS. 3-10 are provided as examples. Other examples may differ from what is described with respect to FIGS. 3-12.

FIG. 11 is a flow diagram illustrating an example process 1100 performed, for example, by a user equipment (UE), in accordance with various aspects of the present disclosure. The example process 1100 is an example of radio link control (RLC) status reporting by a user equipment. The operations of the process 1100 may be implemented by a UE 120.

At block 1102, the user equipment (UE) receives a configuration for a format type of a radio link control (RLC) status report. For example, the UE (e.g., using the antenna 252, DEMOD/MOD 254, MIMO detector 256, receive processor 258, controller/processor 280, memory 282, and/or the like) may receive the configuration. In some aspects, the configuration indicates a full status report, a partial status report, a differential status report, a window start status report, or a compressed status report. The configuration may indicate a configuration range and key performance indicators (KPIs) for status reporting.

At block 1104, the user equipment (UE) determines a size of an uplink grant. For example, the UE (e.g., using the controller/processor 280, memory 282, and/or the like) may determine the size. In some aspects, the UE determines the size of the uplink grant by predicting future uplink grants and/or detecting a current uplink grant.

At block 1106, the user equipment (UE) determines a portion of the uplink grant allocated for the RLC status report based on the size of the uplink grant and the configuration for the format type. For example, the UE (e.g., using the controller/processor 280, memory 282, and/or the like) may determine the portion. In some aspects, the UE determines the portion of the uplink grant allocated for the RLC status report based on uplink data stored in an uplink data buffer.

At block 1108, the user equipment (UE) builds the RLC status report based on the configuration for the format type and the portion of the uplink grant allocated for the RLC status report. For example, the UE (e.g., using the controller/processor 280, memory 282, and/or the like) may build the RLC status report. In some aspects, the UE builds the RLC status report by determining a type of encoding based on the portion of the uplink grant allocated for the RLC status report.

At block 1110, the user equipment (UE) transmits the RLC status report. For example, the UE (e.g., using the antenna 252, DEMOD/MOD 254, TX MIMO processor 266, transmit processor 264, controller/processor 280, memory 282, and/or the like) may transmit the RLC status report.

FIG. 12 is a flow diagram illustrating an example process 1200 performed, for example, by a network device, in accordance with various aspects of the present disclosure. The example process 1200 is an example of radio link control (RLC) status reporting by a network device. The operations of the process 1200 may be implemented by a base station 110.

At block 1202, the base station transmits a code point indicating a format type of a radio link control (RLC) status report. For example, the base station (e.g., using the antenna 234, MOD/DEMOD 232, TX MIMO processor 230, transmit processor 220, controller/processor 240, memory 242, and/or the like) may transmit the code point. In some aspects, the code point indicates a full status report, a partial status report, a differential status report, a window start status report, or a compressed status report.

At block 1204, the base station receives the RLC status report in the format type. For example, the base station (e.g., using the antenna 234, MOD/DEMOD 232, MIMO detector 236, receive processor 238, controller/processor 240, memory 242, and/or the like) may receive the RLC status report. In some aspects, the base station may also receive a UE capability for supported RLC status reporting formats.

### Example Aspects

Aspect 1: A method of wireless communication by a user equipment (UE), comprising: receiving a configuration for a format type of a radio link control (RLC) status report; determining a size of an uplink grant; determining a portion of the uplink grant allocated for the RLC status report based on the size of the uplink grant and the configuration for the format type; building the RLC status report based on the configuration for the format type and the portion of the uplink grant allocated for the RLC status report; and transmitting the RLC status report.

Aspect 2: The method of Aspect 1, in which determining the size of the uplink grant comprises at least one of predicting future uplink grants or detecting a current uplink grant.

Aspect 3: The method of Aspect 1 or 2, in which building the RLC status report further comprises determining a type of encoding based on the portion of the uplink grant allocated for the RLC status report.

Aspect 4: The method of any of the preceding Aspects, further comprising: predicting, with a learning model, whether an unreceived RLC status protocol data unit (PDU) will be received based on an RLC receive window; predicting, with the learning model, a priority of the unreceived RLC status PDU; and building the RLC status report based on the predicting the priority of the unreceived RLC status PDU.

Aspect 5: The method of any of the preceding Aspects, further comprising determining the portion of the uplink grant allocated for the RLC status report based on uplink data stored in an uplink data buffer.

Aspect 6: The method of any of the preceding Aspects, in which the configuration indicates a full status report, a partial status report, a differential status report, a window start status report, or a compressed status report.

Aspect 7: The method of any of the preceding Aspects, further comprising storing a status reporting key performance indicator (KPI) associated with RLC transmission latency and a quantity of duplicated received transmissions.

Aspect 8: The method of any of the preceding Aspects, further comprising reporting the status reporting KPI to a network device.

Aspect 9: The method of any of the preceding Aspects, further comprising reporting a UE capability for supported RLC status reporting formats.

Aspect 10: The method of any of the preceding Aspects, in which the configuration indicates a configuration range and key performance indicators (KPIs) for status reporting.

Aspect 11: The method of any of the preceding Aspects, in which the configuration range indicates reporting a full status report when the size of the uplink grant is equal to or larger than a size of the full status report.

Aspect 12: The method of any of the preceding Aspects, in which the configuration range indicates a percentage of the uplink grant to use for status reporting.

Aspect 13: The method of any of the preceding Aspects, in which the configuration range indicates an upper bound on an amount of time between two status reports, and a minimum amount of time between the two status reports.

Aspect 14: The method of any of the preceding Aspects, in which the KPIs indicate a latency boundary for protocol data units (PDUs) and a percentage of PDUs permitted to be delayed beyond the latency boundary.

Aspect 15: The method of any of the preceding Aspects, further comprising transmitting a KPI violation report in response to at least one status reporting KPI being below a threshold value.

Aspect 16: A method of wireless communication by a network device, comprising: transmitting a code point indicating a format type of a radio link control (RLC) status report; and receiving the RLC status report in the format type.

Aspect 17: The method of Aspect 16, in which the code point indicates a full status report, a partial status report, a differential status report, a window start status report, or a compressed status report.

Aspect 18: The method of Aspect 16 or 17, further comprising receiving from a user equipment (UE) a status reporting key performance indicator (KPI) associated with RLC transmission latency and a quantity of duplicated received transmissions.

Aspect 19: The method of any of the Aspects 16-18, further comprising receiving a UE capability for supported RLC status reporting formats.

Aspect 20: The method of any of the Aspects 16-19, further comprising transmitting a configuration indicating a configuration range and key performance indicators (KPIs) for status reporting.

Aspect 21: The method of any of the Aspects 16-20, in which the configuration range indicates reporting a full status report when a size of an uplink grant is equal to or larger than a size of the full status report.

Aspect 22: The method of any of the Aspects 16-21, in which the configuration range indicates a percentage of an uplink grant to use for status reporting.

Aspect 23: The method of any of the Aspects 16-22, in which the configuration range indicates an upper bound on an amount of time between two status reports, and a minimum amount of time between the two status reports.

Aspect 24: The method of any of the Aspects 16-23, in which the KPIs indicate a latency boundary for protocol data units (PDUs) and a percentage of PDUs permitted to be delayed beyond the latency boundary.

Aspect 25: The method of any of the Aspects 16-24, further comprising receiving a KPI violation report in response to at least one status reporting KPI being below a threshold value.

Aspect 26: An apparatus for wireless communication by a user equipment (UE), comprising: at least one memory; and at least one processor coupled to the at least one memory and configured: to receive a configuration for a format type of a radio link control (RLC) status report; to determine a size of an uplink grant; to determine a portion of the uplink grant allocated for the RLC status report based on the size of the uplink grant and the configuration for the format type; to build the RLC status report based on the configuration for the format type and the portion of the uplink grant allocated for the RLC status report; and to transmit the RLC status report.

Aspect 27: The apparatus of Aspect 26, in which the at least one processor is configured to determine the size of the uplink grant by at least one of predicting future uplink grants or detecting a current uplink grant.

Aspect 28: The apparatus of Aspect 26 or 27, in which the at least one processor is configured to build the RLC status report by determining a type of encoding based on the portion of the uplink grant allocated for the RLC status report.

Aspect 29: The apparatus of any of the Aspects 26-28, in which the at least one processor is configured: to predict, with a learning model, whether an unreceived RLC status protocol data unit (PDU) will be received based on an RLC receive window; to predict, with the learning model, a priority of the unreceived RLC status PDU; and to build the RLC status report based on the predicting the priority of the unreceived RLC status PDU.

Aspect 30: An apparatus for wireless communication by a network device, comprising: at least one memory; and at least one processor coupled to the at least one memory and configured: to transmit a code point indicating a format type of a radio link control (RLC) status report; and to receive the RLC status report in the format type.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication by a user equipment (UE), comprising:
receiving a configuration for a format type of a radio link control (RLC) status report;
determining a size of an uplink grant;
determining a portion of the uplink grant allocated for the RLC status report based on the size of the uplink grant and the configuration for the format type;
building the RLC status report based on the configuration for the format type and the portion of the uplink grant allocated for the RLC status report; and
transmitting the RLC status report.

2. The method of claim 1, in which determining the size of the uplink grant comprises at least one of predicting future uplink grants or detecting a current uplink grant.

3. The method of claim 1, in which building the RLC status report further comprises determining a type of encoding based on the portion of the uplink grant allocated for the RLC status report.

4. The method of claim 1, further comprising:
predicting, with a learning model, whether an unreceived RLC status protocol data unit (PDU) will be received based on an RLC receive window;
predicting, with the learning model, a priority of the unreceived RLC status PDU; and
building the RLC status report based on the predicting the priority of the unreceived RLC status PDU.

5. The method of claim 1, further comprising determining the portion of the uplink grant allocated for the RLC status report based on uplink data stored in an uplink data buffer.

6. The method of claim 1, in which the configuration indicates a full status report, a partial status report, a differential status report, a window start status report, or a compressed status report.

7. The method of claim 1, further comprising storing a status reporting key performance indicator (KPI) associated with RLC transmission latency and a quantity of duplicated received transmissions.

8. The method of claim 7, further comprising reporting the status reporting KPI to a network device.

9. The method of claim 1, further comprising reporting a UE capability for supported RLC status reporting formats.

10. The method of claim 1, in which the configuration indicates a configuration range and key performance indicators (KPIs) for status reporting.

11. The method of claim 10, in which the configuration range indicates reporting a full status report when the size of the uplink grant is equal to or larger than a size of the full status report.

12. The method of claim 10, in which the configuration range indicates a percentage of the uplink grant to use for status reporting.

13. The method of claim 10, in which the configuration range indicates an upper bound on an amount of time between two status reports, and a minimum amount of time between the two status reports.

14. The method of claim 10, in which the KPIs indicate a latency boundary for protocol data units (PDUs) and a percentage of PDUs permitted to be delayed beyond the latency boundary.

15. The method of claim 10, further comprising transmitting a KPI violation report in response to at least one status reporting KPI being below a threshold value.

16. A method of wireless communication by a network device, comprising:
transmitting a code point indicating a format type of a radio link control (RLC) status report; and
receiving the RLC status report in the format type.

17. The method of claim 16, in which the code point indicates a full status report, a partial status report, a differential status report, a window start status report, or a compressed status report.

18. The method of claim 16, further comprising receiving from a user equipment (UE) a status reporting key performance indicator (KPI) associated with RLC transmission latency and a quantity of duplicated received transmissions.

19. The method of claim 16, further comprising receiving a UE capability for supported RLC status reporting formats.

20. The method of claim 16, further comprising transmitting a configuration indicating a configuration range and key performance indicators (KPIs) for status reporting.

21. The method of claim 20, in which the configuration range indicates reporting a full status report when a size of an uplink grant is equal to or larger than a size of the full status report.

22. The method of claim 20, in which the configuration range indicates a percentage of an uplink grant to use for status reporting.

23. The method of claim 20, in which the configuration range indicates an upper bound on an amount of time between two status reports, and a minimum amount of time between the two status reports.

24. The method of claim 20, in which the KPIs indicate a latency boundary for protocol data units (PDUs) and a percentage of PDUs permitted to be delayed beyond the latency boundary.

25. The method of claim 20, further comprising receiving a KPI violation report in response to at least one status reporting KPI being below a threshold value.

26. An apparatus for wireless communication by a user equipment (UE), comprising:
at least one memory; and
at least one processor coupled to the at least one memory and configured:
to receive a configuration for a format type of a radio link control (RLC) status report;
to determine a size of an uplink grant;
to determine a portion of the uplink grant allocated for the RLC status report based on the size of the uplink grant and the configuration for the format type;
to build the RLC status report based on the configuration for the format type and the portion of the uplink grant allocated for the RLC status report; and
to transmit the RLC status report.

27. The apparatus of claim 26, in which the at least one processor is configured to determine the size of the uplink grant by at least one of predicting future uplink grants or detecting a current uplink grant.

28. The apparatus of claim 26, in which the at least one processor is configured to build the RLC status report by determining a type of encoding based on the portion of the uplink grant allocated for the RLC status report.

29. The apparatus of claim 26, in which the at least one processor is configured:
to predict, with a learning model, whether an unreceived RLC status protocol data unit (PDU) will be received based on an RLC receive window;
to predict, with the learning model, a priority of the unreceived RLC status PDU; and
to build the RLC status report based on the predicting the priority of the unreceived RLC status PDU.

30. An apparatus for wireless communication by a network device, comprising:
at least one memory; and
at least one processor coupled to the at least one memory and configured:
to transmit a code point indicating a format type of a radio link control (RLC) status report; and
to receive the RLC status report in the format type.
